(19) United States
(12) Patent Application Publication
(10) Pub. No.: US 2024/0179596 A1
(43) Pub. Date: May 30, 2024

(54) WIRELESS COMMUNICATION SYSTEM, WIRELESS COMMUNICATION CONTROL METHOD, AND WIRELESS COMMUNICATION CONTROL DEVICE

(71) Applicant: NIPPON TELEGRAPH AND TELEPHONE CORPORATION, Tokyo (JP)

(72) Inventors: Hisayoshi KANO, Musashino-shi, Tokyo (JP); Hiroki SHIBAYAMA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/284,868

(22) PCT Filed: Apr. 2, 2021
(86) PCT No.: PCT/JP2021/014388

§ 371 Date: Sep. 29, 2023

(51) Int. Cl. H04W 36/18; H04W 84/06

(52) U.S. Cl. CPC H04W 36/18; H04W 84/06

(57) ABSTRACT

A wireless communication system switches a connection destination of a ground wireless station from a first node station to a second node station. The ground wireless station establishes a link with an absolute node station when a link with the second node station cannot be established before a link with the first node station is disconnected. The absolute node station is connectable to the ground wireless station in an entire communication area and has a connection priority lower than connection priorities of the first node station and the second node station. The ground wireless station switches the connection destination from the first node station to the absolute node station. Thereafter, the ground wireless station switches the connection destination to the second node station after a link with the second node station is established.

### TECHNICAL FIELD

The present invention relates to a wireless communication system, a wireless communication control method, and a wireless communication control apparatus.

### BACKGROUND ART

A wireless communication system in which a ground wireless station (for example, a satellite ground station or a terminal station) and a node station (for example, a satellite relay station or a cellular base station) communicate with each other has been studied. The ground wireless station performs switching processing of switching a node station to which the ground wireless station is to be connected in accordance with movement of the own ground wireless station or the node station. In a case where a communication line and a control line (hereinafter, referred to as a link) between the own ground wireless station and the node station are disconnected during the switching processing, communication is disconnected. As a result, a throughput of the entire system is decreased.

For this reason, it is desirable to perform processing of switching a connection destination to an optimum node station without communication disconnection. For example, in Non Patent Literature 1, handover in a satellite communication system is studied.

### CITATION LIST

### Non Patent Literature

Non Patent Literature 1: Sekiguchi, Fujii, and Tanibayashi, “Study on handover in LTE-based communication between satellite aircrafts”, 2019 IEICE (The Institute of Electronics, Information and Communication Engineers) Information Society Conference, B-3-28, September 2019

### SUMMARY OF INVENTION

### Technical Problem

A problem of node station switching processing in the satellite communication system will be described with reference to FIG. 8 and FIG. 9.

In FIG. 8, a link 86 is established between a satellite ground station 81 and a satellite relay station 83. The satellite relay stations 83, 84, and 85 are non-geostationary satellites, and move from right to left in FIG. 1. The satellite relay station 83 moves away from the satellite ground station 81, and the satellite relay station 84 approaches the satellite ground station 81. The satellite ground station 81 establishes a link 87 with the new satellite relay station 84 and switches the communication route before the link 86 is disconnected and communication with the satellite relay station 83 that is currently performing communication is disconnected. Thereby, communication between the satellite ground station 81 and a terminal station 82 is maintained.

The node station switching processing is based on a premise that the node stations (the satellite relay stations 83, 84, and 85) are densely disposed and that the ground wireless station (the satellite ground station 81 or the terminal station 82) can establish a link with a new node station before communication with a node station that is currently performing communication is disconnected.

However, in practice, the node stations are not necessarily densely disposed for reasons such as beginning of service start and high costs. In the example illustrated in FIG. 9, a distance between a node station (satellite relay station 83) that is currently performing communication and a new node station (satellite relay station 85) is long. For this reason, the satellite ground station 81 cannot establish a link 88 with a new node station before communication with the node station that is currently performing communication is disconnected. As a result, communication is disconnected, and this causes a decrease in the throughput of the entire system.

The present invention has been made to solve the above-described problems, and an object of the present invention is to provide a wireless communication system, a wireless communication control method, and a wireless communication control apparatus capable of switching a connection destination of a ground wireless station to a new node station without communication disconnection.

### Solution to Problem

A first aspect relates to a wireless communication system.

The wireless communication system includes a ground wireless station, a first node station, a second node station, and an absolute node station.

The ground wireless station is located within a communication area.

The first node station is connectable to the ground wireless station in a part of the communication area.

The second node station is connectable to the ground wireless station in a part of the communication area.

The absolute node station is disposed to be connectable to the ground wireless station in the entire communication area, and has a connection priority lower than connection priorities of the first node station and the second node station.

In the case of switching a connection destination of the ground wireless station from the first node station to the second node station, the ground wireless station establishes a link with the absolute node station in a case where a link with the second node station cannot be established before a link with the first node station is disconnected.

Next, the ground wireless station switches the connection destination from the first node station to the absolute node station.

Next, the ground wireless station switches the connection destination to the second node station after a link with the second node station is established.

A second aspect relates to a wireless communication control method for switching a connection destination of a ground wireless station from a first node station to a second node station.

The ground wireless station is located within a communication area.

The first node station is connectable to the ground wireless station in a part of the communication area.

The second node station is connectable to the ground wireless station in a part of the communication area.

The wireless communication control method includes a first step, a second step, and a third step.

The first step is a step of establishing a link between the ground wireless station and an absolute node station in a case where a link between the ground wireless station and the second node station cannot be established before a link between the ground wireless station and the first node station is disconnected. The absolute node station is disposed to be connectable to the ground wireless station in the entire communication area and has a connection priority lower than connection priorities of the first node station and the second node station.

The second step is a step of switching the connection destination from the first node station to the absolute node station.

The third step is a step of switching the connection destination to the second node station after a link between the ground wireless station and the second node station is established.

A third aspect relates to a wireless communication control apparatus for switching a connection destination of a ground wireless station from a first node station to a second node station.

The ground wireless station is located within a communication area.

The first node station is connectable to the ground wireless station in a part of the communication area.

The second node station is connectable to the ground wireless station in a part of the communication area.

The wireless communication control apparatus establishes a link between the ground wireless station and an absolute node station in a case where a link between the ground wireless station and the second node station cannot be established before a link between the ground wireless station and the first node station is disconnected. The absolute node station is disposed to be connectable to the ground wireless station in the entire communication area and has a connection priority lower than connection priorities of the first node station and the second node station.

Next, the wireless communication control apparatus switches the connection destination from the first node station to the absolute node station.

Next, the wireless communication control apparatus switches the connection destination to the second node station after a link between the ground wireless station and the second node station is established.

### Advantageous Effects of Invention

According to the present invention, an absolute node station that can always establish a link with a ground wireless station is disposed. In a case where the ground wireless station switches a connection destination from a node station that is currently performing communication to a new node station, the connection destination can be temporarily switched to the absolute node station. Thereby, it is possible to prevent communication disconnection. Thereafter, a link with a new node station having a higher connection priority is established, and then the connection destination can be switched to the new node station. Therefore, according to the present invention, it is possible to switch the connection destination of the ground wireless station to the new node station without communication disconnection, and it is possible to improve a throughput of the entire system.

### BRIEF DESCRIPTION OF DRAWINGS

FIG. 1 is a conceptual diagram for explaining an outline of a wireless communication system according to an embodiment 1 of the present invention.

FIG. 2 is a diagram for explaining a communication route switching procedure in the wireless communication system according to the embodiment 1 of the present invention.

FIG. 3 is a flowchart illustrating communication route switching processing in a ground wireless station.

FIG. 4 is a conceptual diagram for explaining an outline of a wireless communication system according to an embodiment 2 of the present invention.

FIG. 5 is a diagram for explaining a communication route switching procedure in the wireless communication system according to the embodiment 2 of the present invention.

FIG. 6 is a block diagram illustrating an outline of functions of the ground wireless station.

FIG. 7 is a diagram illustrating a hardware configuration example of a wireless communication control apparatus.

FIG. 8 is a diagram for explaining a problem of node station switching processing in a satellite communication system.

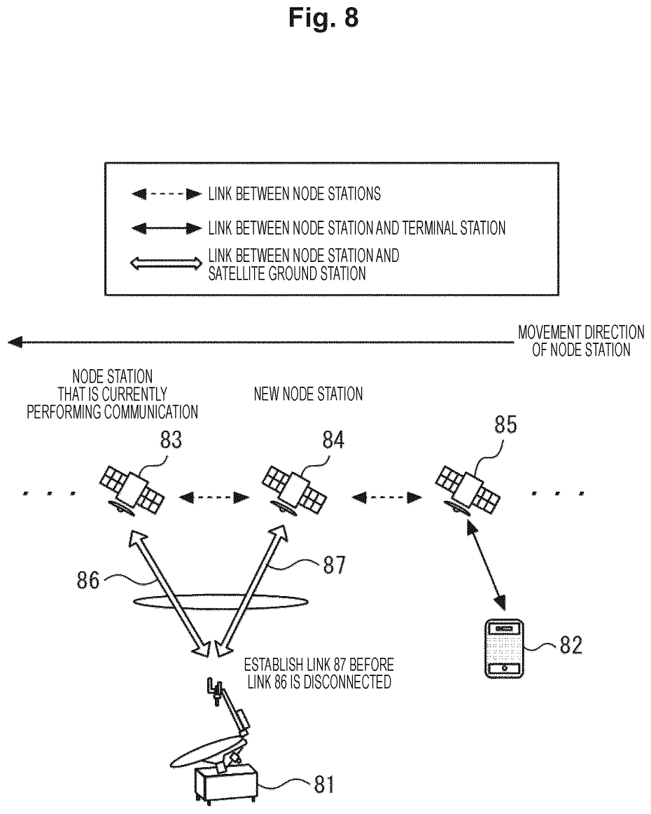

FIG. 9 is a diagram for explaining a problem of node station switching processing in a satellite communication system.

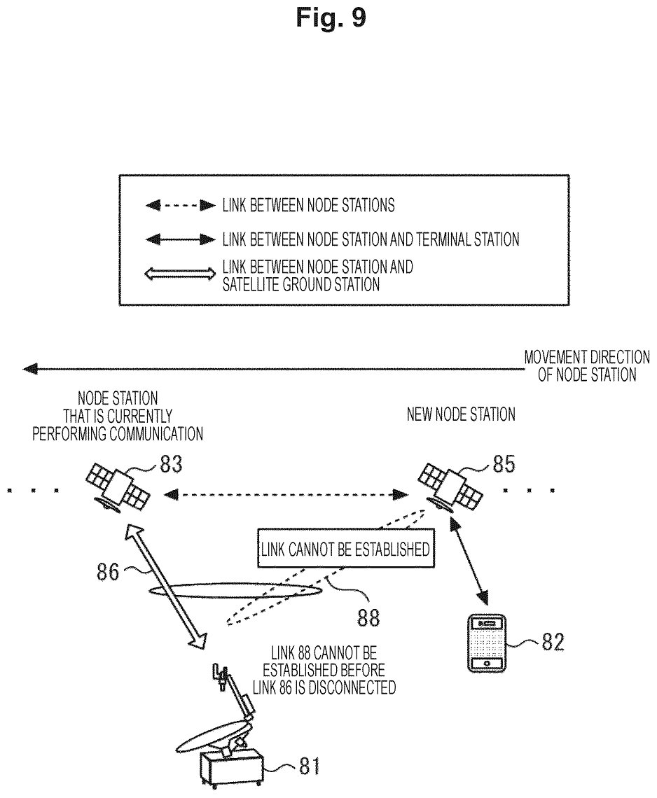

### DESCRIPTION OF EMBODIMENTS

Hereinafter, embodiments of the present invention will be described with reference to the drawings. Here, in a case where a number such as the number of components, a numerical quantity, a quantity, a range, or the like is mentioned in the embodiments to be described below, the present invention is not limited to the mentioned number unless otherwise specified or clearly specified in principle. In addition, a structure or the like to be described in the embodiments described below is not necessarily essential to the present invention unless otherwise specified or clearly specified in principle. Note that common components in the drawings are denoted by the same reference numerals, and redundant description will be omitted.

### Embodiment 1

### (1) Wireless Communication System

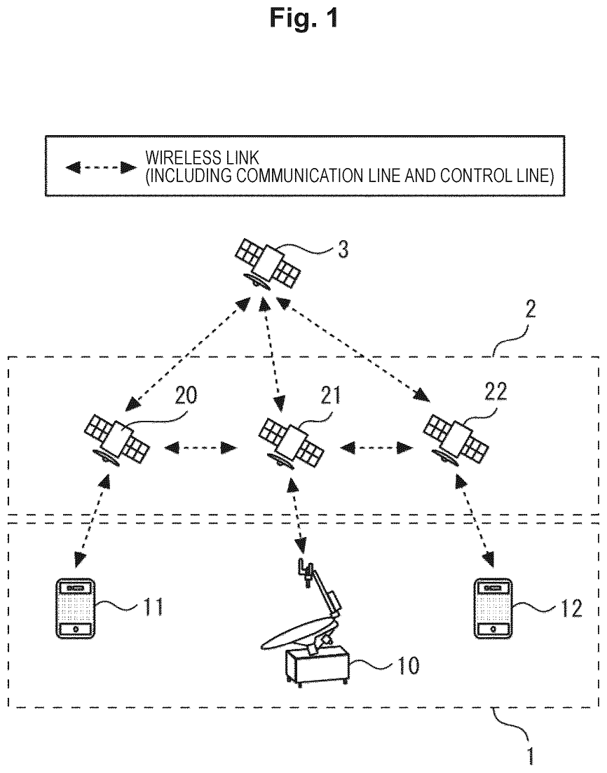

FIG. 1 is a conceptual diagram for explaining an outline of a wireless communication system according to an embodiment 1. The wireless communication system illustrated in FIG. 1 is a satellite communication system including a plurality of ground wireless stations 1, a plurality of node stations 2, and an absolute node station 3.

The absolute node station 3 is disposed to be wirelessly connectable to all the ground wireless stations 1 in an entire communication area. The absolute node station 3 according to the embodiment 1 is a geostationary satellite. Since the geostationary satellite orbits at the same period as a rotation period of the earth, a relative distance between the absolute node station 3 and the ground wireless station 1 hardly changes. For this reason, the absolute node station 3 can always establish a link with the ground wireless station 1. In addition, the absolute node station 3 is a satellite relay station, and can be wirelessly connected to each of the plurality of node stations 2.

The node station 2 is a non-geostationary satellite (mobile satellite) having an altitude lower than an altitude of a geostationary satellite. The node station 2 is, for example, a low earth orbit satellite (LEO), a middle earth orbit satellite (MEO), or a high altitude platform satellite (HAPS). The node station 2 moves from right to left in FIG. 1, and a relative distance between the node station 2 and the ground wireless station 1 changes. The node station 2 is a satellite relay station, and FIG. 1 illustrates satellite relay stations 20, 21, and 22. The satellite relay stations 20, 21, and 22 can be wirelessly connected to each other.

The node station 2 can be wirelessly connected to the ground wireless station 1 in a case where the ground wireless station 1 is located within a communication-possible area of the own node station 2 (a part of the communication area of the absolute node station 3). For example, the satellite relay station 21 can be wirelessly connected to a satellite ground station 10 located within a communication-possible area of the own satellite relay station 21. The satellite relay station 22 can be wirelessly connected to a terminal station 12 located in a communication-possible area of the own satellite relay station 22.

The ground wireless station 1 is located within the communication area of the absolute node station 3. The ground wireless station 1 is a satellite ground station or a terminal station, and FIG. 1 illustrates a satellite ground station 10 and terminal stations 11 and 12. In a state where a wireless link is established as illustrated in FIG. 1, the terminal station 11 can perform communication with the terminal station 12 via the node station 2. The satellite ground station 10 can perform communication with the terminal stations 11 and 12 via the node station 2.

Note that, in the configuration illustrated in FIG. 1, the absolute node station 3 that is a geostationary satellite has a transmission delay larger than a transmission delay of the node station 2 that is a non-geostationary satellite. Therefore, a connection priority between the ground wireless station 1 and the absolute node station 3 is set to be lower than a connection priority between the ground wireless station 1 and the node station 2.

### (2) Outline of Communication Route Switching Processing

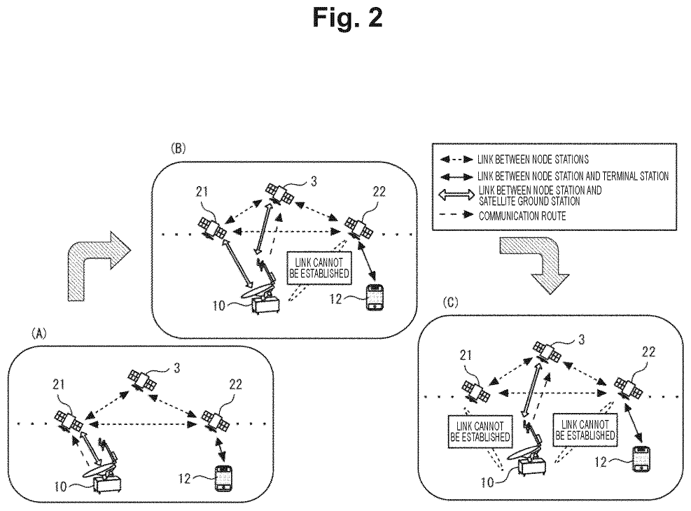

FIG. 2 is a diagram for explaining a communication route switching procedure in the wireless communication system according to the embodiment 1. Processing until a connection destination of the satellite ground station 10 (ground wireless station 1) is switched from the satellite relay station 21 (first node station) to the satellite relay station 22 (second node station) will be described with reference to FIG. 2.

In (A) of FIG. 2, the satellite ground station 10 is performing communication with the terminal station 12 via the satellite relay stations 21 and 22. A link between the satellite ground station 10 and the satellite relay station 21 is established, and a connection destination of the satellite ground station 10 is set as the satellite relay station 21.

(B) of FIG. 2 illustrates a state a certain time before the link between the satellite ground station 10 and the satellite relay station 21 is disconnected. As the satellite relay station 21 moves, a relative distance between the satellite ground station 10 and the satellite relay station 21 increases. The satellite ground station 10 searches for a satellite to be a next connection destination from a certain time before communication with the mobile satellite that is currently performing communication is disconnected. For example, the satellite ground station 10 attempts to establish a link with the satellite relay station 22 (second node station) before the link with the satellite relay station 21 (first node station) is disconnected. In a case where a link between the satellite ground station 10 and the satellite relay station 22 cannot be established, the satellite ground station 10 establishes a link with the absolute node station 3. Thereafter, the satellite ground station 10 switches the connection destination from the satellite relay station 21 (first node station) to the absolute node station 3.

Thereby, the communication route is switched to a route via the absolute node station 3 and the satellite relay station 22, and a communication state between the satellite ground station 10 and the terminal station 12 is maintained. As described above, in a case where a satellite that can establish a link before link disconnection is only the geostationary satellite (the absolute node station 3), the satellite ground station 10 maintains a communication state by performing connection to the geostationary satellite and switching the communication route. Note that the absolute node station 3 is temporarily used to maintain the communication state even though the absolute node station 3 is a satellite relay station having a larger transmission delay and a lower connection priority as compared with the node station 2 as described above.

(C) of FIG. 2 illustrates a state where the link between the satellite ground station 10 and the satellite relay station 21 is disconnected. The satellite relay station 21 moves away from the satellite ground station 10, and thus the link between the satellite relay station 21 and the satellite ground station 10 is disconnected. Thereafter, for a while, the satellite ground station 10 cannot establish a link with a station other than the absolute node station 3.

Thereafter, the satellite relay station 22 approaches the satellite ground station 10, and a link can be established between the satellite ground station 10 and the satellite relay station 22. After a link between the satellite ground station 10 and the satellite relay station 22 (second node station) is established, the satellite ground station 10 switches the connection destination to the satellite relay station 22. By switching the connection destination of the satellite ground station 10 to the satellite relay station 22 having a connection priority higher than a connection priority of the absolute node station 3, communication quality is improved.

### (3) Flowchart of Communication Route Switching Processing

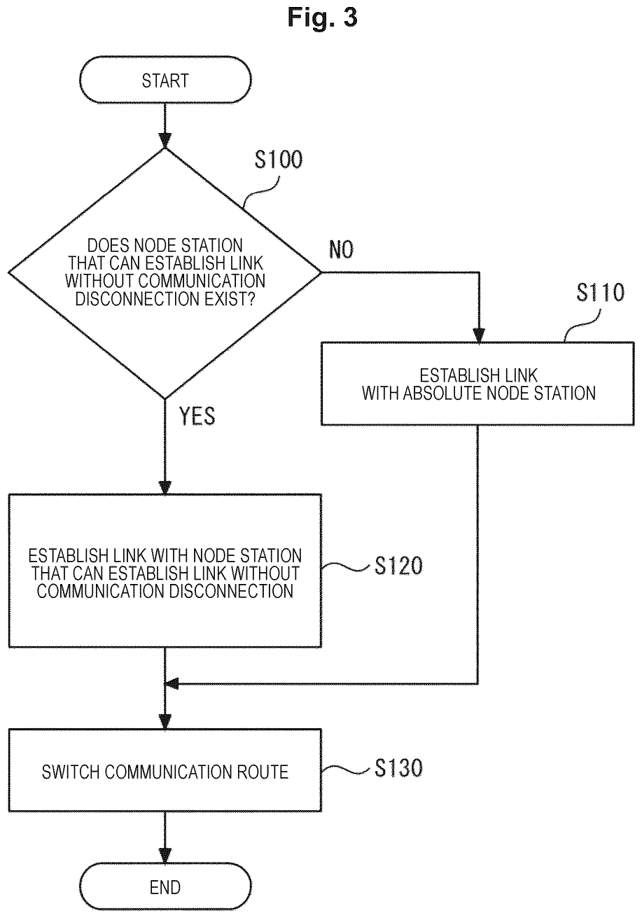

FIG. 3 is a flowchart illustrating communication route switching processing in the ground wireless station 1. As described above, when it is a certain time before the link with the node station that is currently performing communication is disconnected, the ground wireless station 1 executes communication route switching processing of selecting a node station to be newly connected and switching the communication route. The communication route switching processing is executed in a case where a start processing in another sub-routine is satisfied. The start condition is based on a case where an intensity of a radio wave is equal to or lower than a setting value, a case where a relative distance between the ground wireless station 1 and the node station that is currently performing communication is equal to or longer than a setting value, a case where a predetermined time is elapsed, a case where the current connection destination is the absolute node station, or the like. As an example, an initial state is a state where the ground wireless station 1 (satellite ground station 10) and the first node station (satellite relay station 21) are connected to each other.

In step S100, it is determined whether or not another node station 2 (second node station) that can establish a link without communication disconnection exists. Whether or not a link can be established can be determined based on, for example, that an intensity of a radio wave is equal to or higher a threshold value and that a relative distance is equal to or shorter than a threshold value. In a case where a second node station that can establish a link does not exist, that is, in a case where a link can be established only with the absolute node station 3, processing of step S110 is executed.

In step S110, the ground wireless station 1 (satellite ground station 10) establishes a link with the absolute node station 3. Next, processing of step S130 is executed.

In step S130, the ground wireless station 1 (satellite ground station 10) switches the connection destination from the first node station (satellite relay station 21) to the absolute node station 3. Thereby, the communication route is switched from a route via the first node station (satellite relay station 21) to a route via the absolute node station 3. Thereafter, this routine is ended.

By processing of step S130, the connection destination is switched to the absolute node station 3, and the communication route switching processing is executed again in a next control period. Until the determination condition of step S100 is satisfied, a communication route via the absolute node station 3 is adopted (step S110 and step S130).

On the other hand, in a case where a node station 2 that can establish a link is detected, the determination condition of step S100 is satisfied. For example, in a case where a relative distance between the second node station (satellite relay station 22) and the ground wireless station 1 (satellite ground station 10) decreases, the determination condition of step S100 is satisfied. Next, processing of step S120 is executed.

In step S120, the ground wireless station 1 establishes a link with the node station 2 (second node station) that can establish a link without communication disconnection. For example, the ground wireless station 1 (satellite ground station 10) establishes a link with the second node station (satellite relay station 22). Thereafter, processing of step S130 is executed.

In step S130, the ground wireless station 1 (satellite ground station 10) switches the connection destination from the absolute node station 3 to the second node station (satellite relay station 22). The second node station has a connection priority higher than a connection priority of the absolute node station 3 (for example, a transmission delay is small, and an intensity of a radio wave is high). Thereby, the communication route is switched from a route via the absolute node station 3 to a route via the second node station (satellite relay station 22). Thereafter, this routine is ended.

### (4) Effects

As described above, according to the system of the present embodiment, the absolute node station 3 that can always establish a link with the ground wireless station 1 is disposed. In a case where the ground wireless station switches a connection destination from a node station that is currently performing communication to a new node station, the connection destination can be temporarily switched to the absolute node station. Thereby, it is possible to prevent communication disconnection. Thereafter, a link with a node station having a higher connection priority is established, and then the connection destination can be switched to the new node station. Therefore, according to the present embodiment, it is possible to switch the connection destination of the ground wireless station to the new node station without communication disconnection, and it is possible to improve a throughput of the entire system.

### Embodiment 2

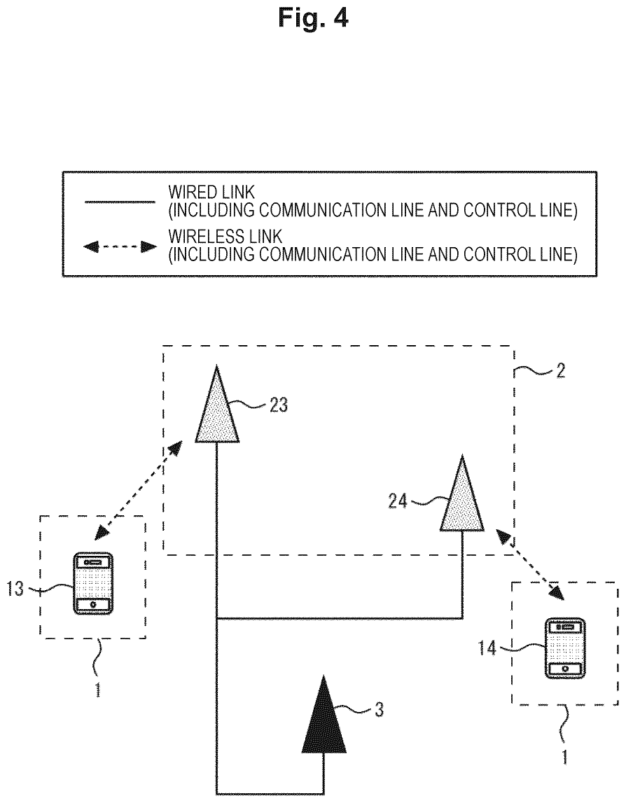

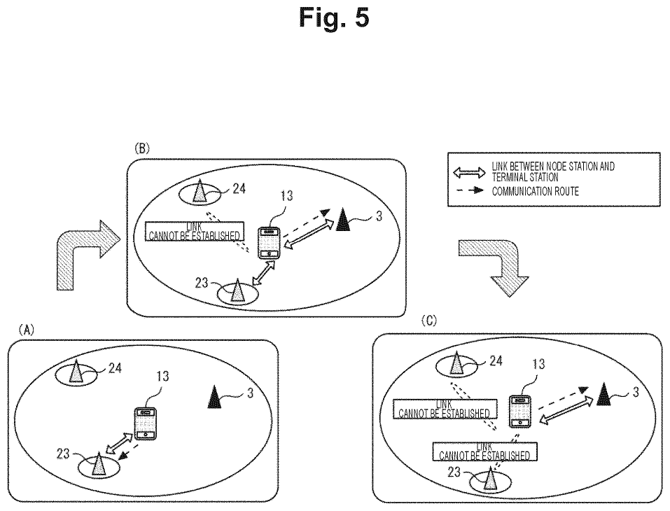

Next, an embodiment 2 of the present invention will be described with reference to FIG. 4 and FIG. 5.

### (1) Wireless Communication System

FIG. 4 is a conceptual diagram for explaining an outline of a wireless communication system according to an embodiment 2. Similar to the wireless communication system according to the embodiment 1, the wireless communication system illustrated in FIG. 4 includes a plurality of ground wireless stations 1, a plurality of node stations 2, and an absolute node station 3.

The absolute node station 3 is disposed to be wirelessly connectable to all the ground wireless stations 1 in an entire communication area. The absolute node station 3 is a cellular base station having a cell radius larger than a cell radius of the node station 2. The absolute node station 3 is connected to each of the plurality of node stations 2 by wire.

The node station 2 is a cellular base station having a cell radius smaller than the cell radius of the absolute node station 3. In FIG. 4, cellular base stations 23 and 24 are illustrated. The cellular base stations 23 and 24 are connected to each other by wire.

The node station 2 can be wirelessly connected to the ground wireless station 1 in a case where the ground wireless station 1 is located within a communication-possible area of the own node station 2 (a part of the communication area of the absolute node station 3). For example, the cellular base station 23 can be wirelessly connected to a terminal station 13 located in a communication-possible area of the own cellular base station 23. The cellular base station 24 can be wirelessly connected to a terminal station 14 located in a communication-possible area of the own cellular base station 24.

The ground wireless station 1 is located within the communication area of the absolute node station 3. In FIG. 4, terminal stations 13 and 14 are illustrated. In a state where a wireless link is established as illustrated in FIG. 4, the terminal station 13 can perform communication with the terminal station 14 via the node station 2.

Note that a connection priority between the ground wireless station 1 and the absolute node station 3 is set to be lower than a connection priority between the ground wireless station 1 and the node station 2.

### (2) Outline of Communication Route Switching Processing

FIG. 5 is a diagram for explaining a communication route switching procedure in the wireless communication system according to the embodiment 2. Processing until a connection destination of the terminal station 13 (ground wireless station 1) is switched from the cellular base station 23 (first node station) to the cellular base station 24 (second node station) will be described with reference to FIG. 5.

In (A) of FIG. 5, the terminal station 13 is performing communication with the terminal station 14 (not illustrated) via the cellular base stations 23 and 24 having a small cell radius. A link between the terminal station 13 and the cellular base station 23 is established, and a connection destination of the terminal station 13 is set to the cellular base station 23.

(B) of FIG. 5 illustrates a state a certain time before the link between the terminal station 13 and the cellular base station 23 is disconnected. As the terminal station 13 moves, a relative distance between the terminal station 13 and the cellular base station 23 increases. The terminal station 13 searches for a cellular base station to be a next connection destination from a certain time before communication with the cellular base station that is currently performing communication is disconnected. For example, the terminal station 13 attempts to establish a link with the cellular base station 24 (second node station) before the link with the cellular base station 23 (first node station) is disconnected. In a case where a link between the terminal station 13 and the cellular base station 24 cannot be established, the terminal station 13 establishes a link with the absolute node station 3. Thereafter, the terminal station 13 switches the connection destination from the cellular base station 23 (first node station) to the absolute node station 3.

Thereby, the communication route is switched to a route via the absolute node station 3 and the cellular base station 24, and a communication state between the terminal station 13 and the terminal station 14 is maintained. As described above, in a case where a cellular base station that can establish a link before link disconnection is only the absolute node station 3 having a large cell radius, the terminal station 13 maintains a communication state by performing connection to the absolute node station 3 and switching the communication route. Note that the absolute node station 3 is temporarily used to maintain the communication state although the absolute node station 3 is a cellular base station having a lower connection priority as compared with the node station 2 as described above.

(C) of FIG. 5 illustrates a state where the link between the terminal station 13 and the cellular base station 23 is disconnected. As the terminal station 13 moves away from the cellular base station 23, the link between the terminal station 13 and the cellular base station 23 is disconnected. Thereafter, for a while, the terminal station 13 cannot establish a link with a station other than the absolute node station 3.

Thereafter, the terminal station 13 approaches the cellular base station 24, and a link can be established between the terminal station 13 and the cellular base station 24. After a link between the terminal station 13 and the cellular base station 24 (second node station) is established, the terminal station 13 switches the connection destination to the cellular base station 24. By switching the connection destination of the satellite ground station 10 to the satellite relay station 22 having a connection priority higher than a connection priority of the absolute node station 3, communication quality is improved.

### (3) Flowchart of Communication Route Switching Processing

The flowchart of FIG. 3 described in the embodiment 1 is also applied to the present embodiment. The description of FIG. 3 described above is the same except that the example of the ground wireless station 1 is the terminal station 13, that the example of the first node station is the cellular base station 23, and that the example of the second node station is the cellular base station 24.

### (4) Effects

As described above, according to the system of the present embodiment, the same effects as those of the embodiment 1 are obtained. That is, according to the present embodiment, it is possible to switch the connection destination of the ground wireless station to the new node station without communication disconnection, and it is possible to improve a throughput of the entire system.

### (Hardware Configuration Example)

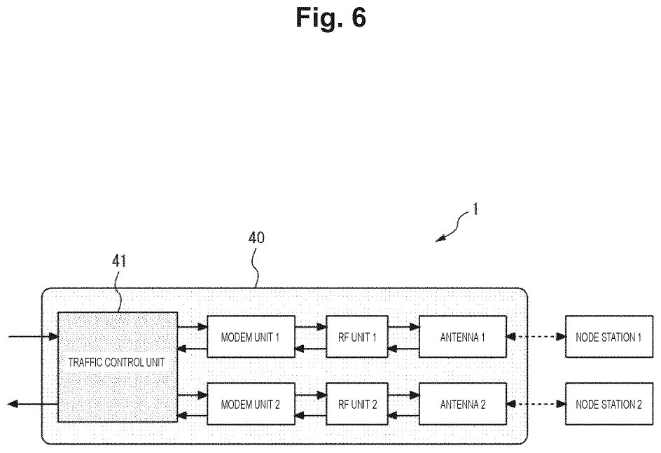

FIG. 6 is a block diagram illustrating an outline of functions of the ground wireless station 1 according to each of the above-described embodiments. The ground wireless station 1 includes a wireless communication control apparatus 40. The wireless communication control apparatus 40 includes a traffic control unit 41. The traffic control unit 41 performs the communication route switching processing described above. In addition, the wireless communication control apparatus 40 includes two systems each of which includes a modem unit, an RF unit, and an antenna. Note that the traffic control unit 41 may be provided in the ground wireless station 1 or may be provided outside the ground wireless station 1. In addition, the ground wireless station 1 may include a plurality of antennas or may include one high-performance antenna.

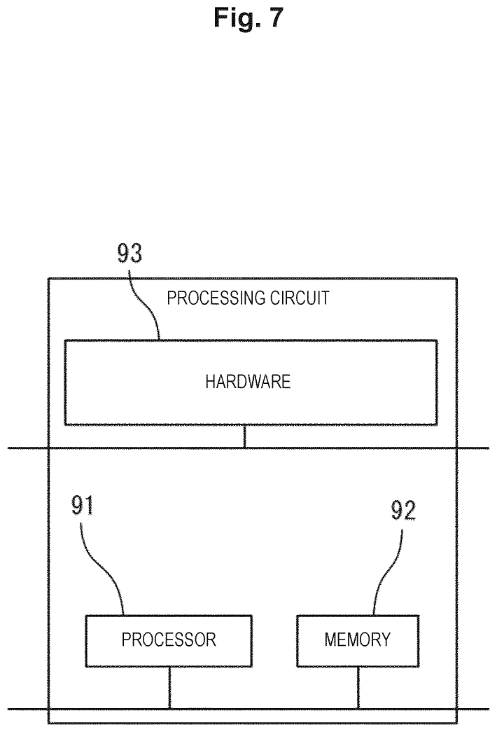

FIG. 7 is a conceptual diagram illustrating a hardware configuration example of a processing circuit included in the traffic control unit 41 according to the above-described embodiment. The functions described above are implemented by the processing circuit. As an aspect, the processing circuit includes at least one processor 91 and at least one memory 92. As another aspect, the processing circuit includes at least one piece of dedicated hardware 93.

In the case where the processing circuit includes the processor 91 and the memory 92, each function is implemented by software, firmware, or a combination of software and firmware. At least one of the software or the firmware is described as a program. At least one of the software and the firmware is stored in the memory 92. In a case where the processor 91 reads and executes the program stored in the memory 92, each function is implemented.

In the case where the processing circuit includes dedicated hardware 93, the processing circuit is, for example, a single circuit, a combined circuit, or a programmed processor, or a combination thereof. Each function is implemented by the processing circuit.

A part or all of the functions of the traffic control unit 41 may be implemented by hardware, or may be implemented as a program to be executed by a processor. That is, the traffic control unit 41 can also be implemented by a computer and a program, and the program can be provided by being recorded in a recording medium or through a network.

As described above, the embodiments of the present invention have been described. On the other hand, the present invention is not limited to the embodiments, and various modifications can be made within a range without departing from the gist of the present invention.

### REFERENCE SIGNS LIST

1 Ground wireless station
2 Node station
3 Absolute node station
10 Satellite ground station
11, 12, 13, 14 Terminal station
20, 21, 22 Satellite relay station
23, 24 Cellular base station
40 Wireless communication control apparatus
41 Traffic control unit
81 Satellite ground station
82 Terminal station
83, 84, 85 Satellite relay station
86, 87, 88 Link
91 Processor
92 Memory
93 Hardware

1. A wireless communication system comprising:
a ground wireless station for use within a communication area;
a first node station that is connectable to the ground wireless station in a part of the communication area;
a second node station that is connectable to the ground wireless station in a part of the communication area; and
an absolute node station that is disposed to be connectable to the ground wireless station in the entire communication area and has a connection priority lower than connection priorities of the first node station and the second node station,
wherein, in a case of switching a connection destination of the ground wireless station from the first node station to the second node station,
the ground wireless station comprises circuitry configured to:
establish a link with the absolute node station in a case where a link with the second node station cannot be established before a link with the first node station is disconnected,
switch the connection destination from the first node station to the absolute node station, and
switch the connection destination to the second node station after a link with the second node station is established.

2. The wireless communication system according to claim 1, wherein:
the ground wireless station is a satellite ground station or a terminal station,
the absolute node station is a geostationary satellite, and
each of the first node station and the second node station is a non-geostationary satellite having an altitude lower than an altitude of the geostationary satellite.

3. The wireless communication system according to claim 1, wherein:
the ground wireless station is a terminal station, and
each of the first node station, the second node station, and the absolute node station is a cellular base station.

4. A wireless communication control method for switching a connection destination of a ground wireless station from a first node station to a second node station,
the ground wireless station being located within a communication area,
the first node station being connectable to the ground wireless station in a part of the communication area, and
the second node station being connectable to the ground wireless station in a part of the communication area,
the wireless communication control method comprising:
establishing a link between the ground wireless station and an absolute node station in a case where a link between the ground wireless station and the second node station cannot be established before a link between the ground wireless station and the first node station is disconnected, the absolute node station being disposed to be connectable to the ground wireless station in the entire communication area and having a connection priority lower than connection priorities of the first node station and the second node station;
switching the connection destination from the first node station to the absolute node station; and
switching the connection destination to the second node station after a link between the ground wireless station and the second node station is established.

5. The wireless communication control method according to claim 4, wherein:
the ground wireless station is a satellite ground station or a terminal station,
the absolute node station is a geostationary satellite, and
each of the first node station and the second node station is a non-geostationary satellite having an altitude lower than an altitude of the geostationary satellite.

6. The wireless communication control method according to claim 4, wherein:
the ground wireless station is a terminal station, and
each of the first node station, the second node station, and the absolute node station is a cellular base station.

7. A wireless communication control apparatus for switching a connection destination of a ground wireless station from a first node station to a second node station,
the ground wireless station for use within a communication area,
the first node station being connectable to the ground wireless station in a part of the communication area, and
the second node station being connectable to the ground wireless station in a part of the communication area,
wherein the wireless communication control apparatus includes circuitry configured to:
establish a link between the ground wireless station and an absolute node station in a case where a link between the ground wireless station and the second node station cannot be established before a link between the ground wireless station and the first node station is disconnected, the absolute node station being disposed to be connectable to the ground wireless station in the entire communication area and having a connection priority lower than connection priorities of the first node station and the second node station,
switch the connection destination from the first node station to the absolute node station, and
switch the connection destination to the second node station after a link between the ground wireless station and the second node station is established.

8. The wireless communication control apparatus according to claim 7, wherein;
the ground wireless station is a satellite ground station or a terminal station,
the absolute node station is a geostationary satellite, and
each of the first node station and the second node station is a non-geostationary satellite having an altitude lower than an altitude of the geostationary satellite.
